(19) United States
(12) Patent Application Publication
(10) Pub. No.: US 2019/0110559 A1
(43) Pub. Date: Apr. 18, 2019

(54) ZIPPER LOCK

(71) Applicants: Hsin-Chung CHEN, Taipei City (TW); Image Match Design Inc., Zhubei City (TW)

(72) Inventor: Hsin-Chung CHEN, Taipei City (TW)

(21) Appl. No.: 16/158,045

(22) Filed: Oct. 11, 2018

(30) Foreign Application Priority Data
Oct. 13, 2017 (TW) 106135167

(51) Int. Cl. A44B 19/30; E05B 47/00; G07C 9/00

(52) U.S. Cl. CPC A44B 19/301; A44B 19/303; E05B 47/0002; E05B 65/52; G07C 9/00563; A44D 2203/00; E05B 47/0038

(57) ABSTRACT

A zipper lock includes either two sliders or a slider and a lock box, and two locking members are disposed thereon, respectively, such that the two sliders or the slider and the lock box can be locked together by joining the two locking members. The zipper lock further includes an unlocking circuit for unlocking the two sliders otherwise locked together or unlocking the slider and lock box otherwise locked together.

### CROSS-REFERENCE TO RELATED APPLICATIONS

This application claims the priority benefit of Taiwan Application No. 106135167, filed 13 Oct. 2017, now Taiwan Pat. No. I. 631268, the contents of which in its entirety are herein incorporated by reference.

### BACKGROUND OF THE INVENTION

A zipper is a device whereby two pieces of fabric are temporarily coupled together and is usually applicable to garments, suitcases, hand bags, and backpacks. As shown in FIG. 1, a conventional zipper includes two tapes 10 and 12, two rows of teeth 14 attached to the two tapes 10 and 12, respectively, a slider 16, a starting end 20 and a terminating end 22. The slider 16 has a puller 18 whereby a user slides the slider 16 easily. The sliding of the slider 16 causes the two rows of teeth 14 to mesh with each other or separate from each other. When the slider 16 is moved to the starting end 20 of the zipper, the zipper is fully opened. When the slider 16 is moved to the terminating end 22 of the zipper, the zipper is fully closed. FIG. 2 shows another conventional zipper which also includes two tapes 10 and 12 and two rows of teeth 14; however, it has two sliders 24 and 26. When the two sliders 24 and 26 are in contact with each other, the zipper is fully closed. When the two sliders 24 and 26 separate, the zipper is opened.

Conventional zippers cannot be locked. As a result, everybody can open the zippers easily, and in consequence the zippers are unsafe. Therefore, it is desired a zipper lock capable of locking a zipper.

### BRIEF SUMMARY OF THE INVENTION

An objective of the present invention is to provide a zipper lock capable of locking a zipper.

According to the present invention, a zipper lock comprises two sliders and an unlocking circuit. Each of the sliders has a locking member, and the two locking members can be joined to lock the two sliders together. The unlocking circuit unlocks the two otherwise joined locking members. The unlocking circuit determines, in various ways, whether to unlock the locking members. One of the ways requires using fingerprints. The two locking members are disposed at front ends of the two sliders, respectively, or on the pullers of the two sliders, respectively.

According to the present invention, a zipper lock comprises a slider, a lock box, and an unlocking circuit. Each of the slider and the lock box has a locking member, and the locking members can be joined to lock the slider and the lock box together. The lock box is disposed at the terminating end of the zipper. The unlocking circuit unlocks the two otherwise joined locking members. The unlocking circuit determines, in various ways, whether to unlock the locking members. One of the ways requires using fingerprints.

A zipper lock according to the present invention prevents a zipper from being opened by unauthorized persons, thereby enhancing the safety of the zipper.

### BRIEF DESCRIPTION OF THE DRAWINGS

FIG. 1 shows a conventional zipper;

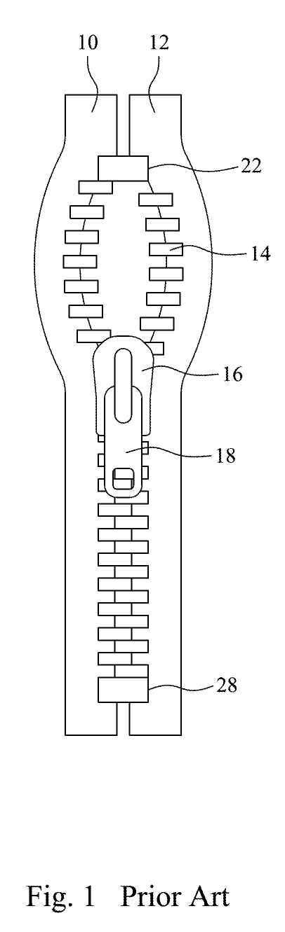

FIG. 2 shows another conventional zipper;

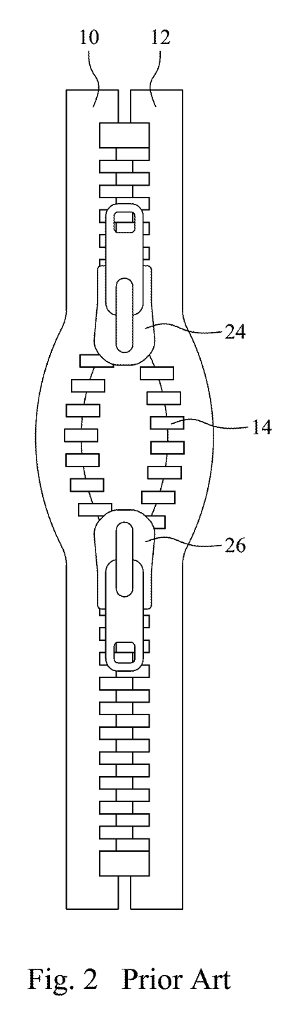

FIG. 3 is a cross-sectional view of the first embodiment according to the present invention;

FIG. 4 is a top view of the first embodiment according to the present invention;

FIG. 5 depicts an embodiment of the locking member shown in FIG. 3;

FIG. 6 is a cross-sectional view of the second embodiment according to the present invention;

FIG. 7 is a top view of the puller shown in FIG. 6;

FIG. 8 shows the third embodiment according to the present invention;

FIG. 9 shows the fourth embodiment according to the present invention; and

FIG. 10 shows the fifth embodiment according to the present invention.

### DETAILED DESCRIPTION OF THE INVENTION

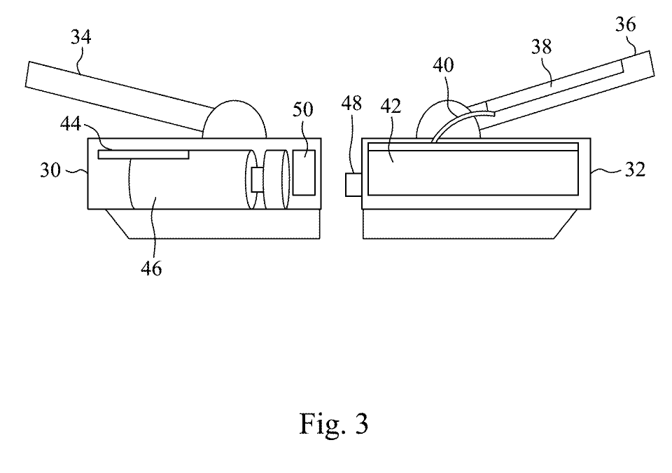

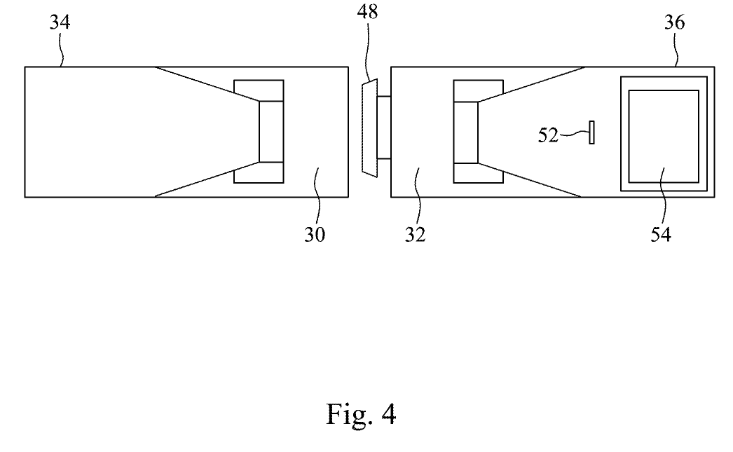

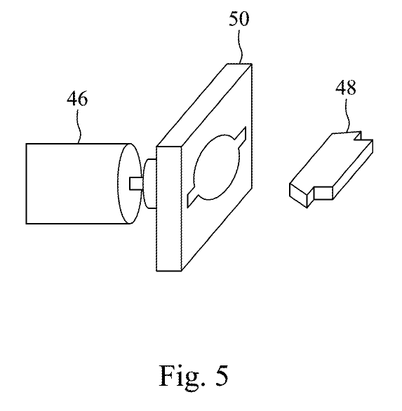

FIG. 3 is a cross-sectional view of the first embodiment according to the present invention, and FIG. 4 is its top view. Referring to FIG. 3 and FIG. 4, a zipper lock comprises sliders 30 and 32 and an unlocking circuit, which includes a printed circuit board 38, a flexible circuit board 40, a battery 42, a control panel 44, a motor 46, and a fingerprint sensor 54. The battery 42 supplies power to each component of the unlocking circuit. In this embodiment, in the two sliders 30 and 32 are the components of the unlocking circuit all over the place. In another embodiment, the components of the unlocking circuit are disposed in the same slider 30 or 32. The slider 30 comprises a puller 34 and a locking member 50, and the slider 32 comprises a puller 36 and a locking member 48. A user pulls the pullers 34 and 36 to move the sliders 30 and 32, respectively. The fingerprint sensor 54 is embedded in the puller 36, and the locking member 48 is disposed at the front end of the slider 32. Similarly, the locking member 50 is disposed at the front end of the slider 30. The locking members 48 and 50 can be implemented in different manners. The embodiment illustrated by FIG. 5 is exemplified by a conventional mechanical structure, in which the locking members 48 and 50 are a lock hook and a mechanical latch, respectively. When the two sliders 30 and 32 are pulled and joined together, the control panel 44 controls the motor 46 to drive the locking member 50 (mechanical latch) to fasten the locking member 48 (lock hook) in place; meanwhile, the two sliders 30 and 32 are locked together and thus cannot be separated, and in consequence the zipper cannot be opened. To open the zipper, the user presses the fingerprint sensor 54 with his or her finger. An indicator lamp 52 indicates whether the user's fingerprint detected with the fingerprint sensor 54 passes verification. If the fingerprint passes verification, the printed circuit board 38 sends an unlocking command to the control panel 44 through the flexible circuit board 40 and a flexible flat cable (not shown). Afterward, the control panel 44 controls the motor 46 to drive the locking member 50 (mechanical latch) to unlock the locking member 48 (lock hook), thereby separating the two sliders 30 and 32.

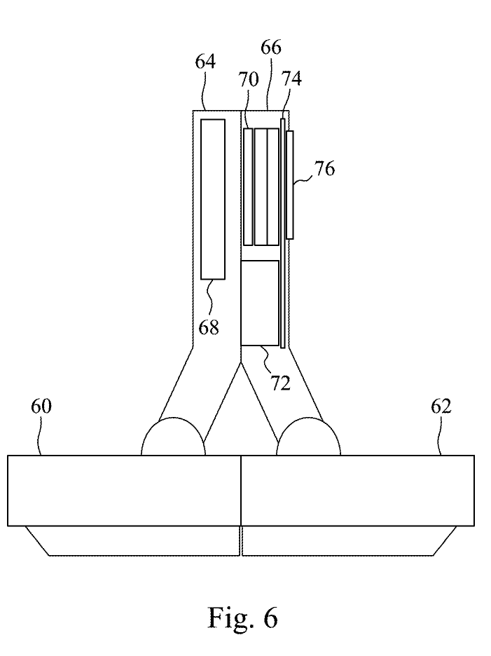

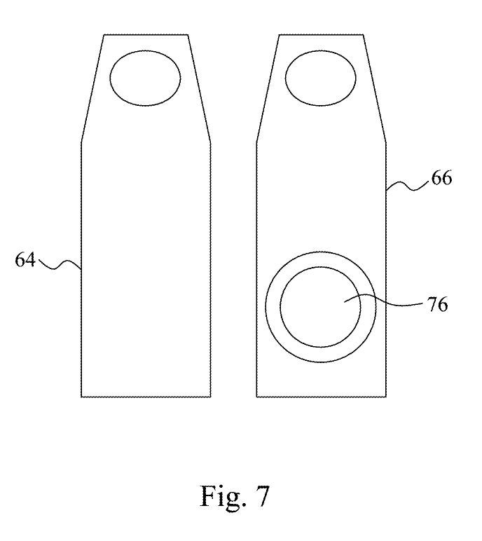

FIG. 6 is a cross-sectional view of the second embodiment according to the present invention, and FIG. 7 is a top view of the puller shown in FIG. 6. Referring to FIG. 6 and FIG. 7, the zipper lock comprises sliders 60 and 62 and an unlocking circuit, which includes a battery 72, a printed circuit board 74, and a fingerprint sensor 76. The battery 72 supplies power to each component of the unlocking circuit. The slider 60 comprises a puller 64 and a locking member 68, and the slider 62 comprises a puller 66 and a locking member 70. In this embodiment, the locking members 68 and 70 are a permanent magnet and an electric magnet, respectively, and are embedded in the pullers 64 and 66, respectively. The electric magnet (locking member 70) has no magnetism (i.e., generates no magnetic force) in the absence of a passing electric current. Therefore, when the pullers 64 and 66 approach each other, the permanent magnet (locking member 68) attracts the puller 66 and thus causes the pullers 64 and 66 to join together. At this point in time, the sliders 60 and 62 cannot be separated, and thus the zipper cannot be opened; hence, the zipper is locked. To open the zipper, the user presses the fingerprint sensor 76 with his or her finger. If the user's fingerprint detected with the fingerprint sensor 76 passes verification, the printed circuit board 74 sends a command causing an electric current to pass through the electric magnet so that the electric magnet produces magnetism opposite to that of the permanent magnet. This allows the electric magnet and the permanent magnet repel each other, and thus the pullers 64 and 66 separate, thereby unlocking the zipper.

In another embodiment, the permanent magnet (locking member 68) and the electric magnet (locking member 70) as illustrated in FIG. 6 are located at any points outside the pullers, for example, disposed at the front ends of the sliders 60 and 62, respectively. Furthermore, the permanent magnet (locking member 68) may be replaced with another electric magnet. In the embodiment illustrated by FIG. 6 and FIG. 7, only the puller 66 accommodates the fingerprint sensor 76. However, in a variant embodiment, the two pullers 64 and 66 accommodate the fingerprint sensors 76 so that the user can unlock the zipper with both hands, thereby enhancing ease of use of the zipper lock according to the present invention. As shown in FIG. 6, by electromagnetic control, the locking members 68 and 70 allow the pullers 64 and 66 to join together and thus render the zipper capable of being locked, but any other way to allow the pullers 64 and 66 to join together is also included in the scope of the present invention. For instance, as shown in FIG. 5, a lock hook (locking member 48) and a mechanical latch (locking member 50) lock the pullers 64 and 66 together.

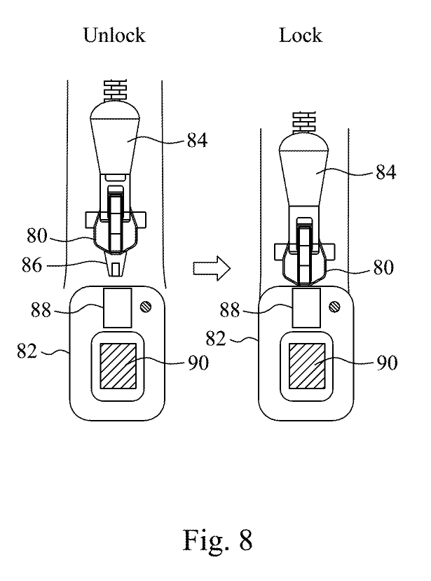

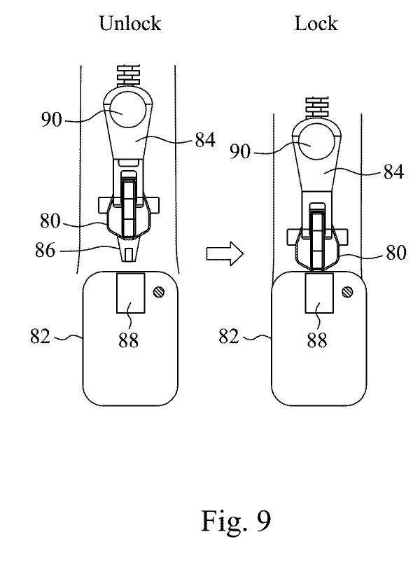

FIG. 8 shows another zipper lock of the third embodiment according to the present invention, which comprises a slider 80, a lock box 82, and an unlocking circuit. The unlocking circuit comprises a fingerprint sensor 90, a control circuit (not shown), a battery (not shown), and a transmission unlocking device (not shown). The transmission unlocking device is a motor or a solenoid valve. The control circuit, the battery, and the transmission unlocking device are either collectively disposed in the slider 80 or the lock box 82, or separately disposed in the slider 80 and the lock box 82. The control circuit, the battery, and the transmission unlocking device are disclosed in the prior art and thus, for the sake of brevity, are not described herein again. The slider 80 comprises a puller 84 and a locking member 86. The user pulls the puller 84 to move the slider 80. The locking member 86 comprises a pin. The lock box 82 is fixed to the terminating end of the zipper and comprises a locking member 88. The locking member 88 comprises a notch. As shown in FIG. 8, when the slider 80 and the lock box 82 are joined together, a pin (locking member 86) disposed at the front end of the slider 80 is inserted into and thus engaged with the notch (locking member 88) of the lock box 82, and in consequence the slider 80 and the lock box 82 are locked together and thus cannot be separated; hence, the zipper cannot be opened and thus is capable of being locked. To open the zipper, the user presses the fingerprint sensor 90 with his or her finger. If the fingerprint detected with the fingerprint sensor 90 passes verification, the control circuit controls the transmission unlocking device to separate the locking member 86 (pin) from the locking member 88 (notch), thereby achieving the unlocking function. FIG. 9 shows a zipper lock of the fourth embodiment according to the present invention. The embodiment shown in FIG. 9 is different from the third embodiment shown in FIG. 8 in that the zipper lock illustrated by FIG. 9 requires that the fingerprint sensor 90 be disposed on the puller 84 of the slider 80.

In the embodiments illustrated by FIG. 8 and FIG. 9, the locking members 86 and 88 are each implemented as a mechanical structure. In another embodiment, the locking members 86 and 88 are each implemented by another means, for example, electromagnetically controlled, as shown in FIG. 6. In the embodiments illustrated by FIG. 8 and FIG. 9, the locking member 86 is disposed at the front end of the slider 80. In another embodiment, the locking member 86 is disposed at another position, for example, on the puller 84.

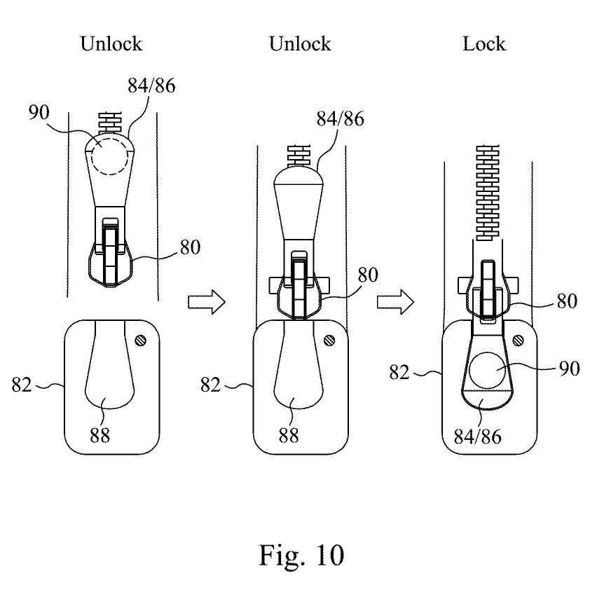

FIG. 10 shows a zipper lock of the fifth embodiment according to the present invention, which comprises a slider 80, a lock box 82, a puller 84, and a locking member 86 as shown in FIG. 8, as well as a locking member 88 and a fingerprint sensor 90. The differences in the zipper lock between FIG. 8 and FIG. 10 are as follows: the puller 84 of FIG. 10 is not only used to pull the slider 80 and used as the locking member 86 but also accommodates the fingerprint sensor 90; as shown in FIG. 10, the locking member 88 comprises a puller recess for accommodating the puller 84; as shown in FIG. 10, as soon as the slider 80 approaches the lock box 82, the puller 84 enters the puller recess (locking member 88) of the lock box 82 so that, upon the contact of the puller 84 with the lock box 82, a contact sense signal is generated. The locking member 88 locks the puller 84 with a mechanical structure or in an electromagnetic manner such that the slider 80 and the lock box 82 are locked together and thus cannot be separated; hence, the zipper cannot be opened and thus is capable of being locked. To open the zipper, the user presses the fingerprint sensor 90 on the puller 84 with his or her finger. If the fingerprint detected with the fingerprint sensor 90 passes verification, the locking member 88 releases the puller 84, so as to achieve the unlocking function.

All the above embodiments illustrate achieving the unlocking function based on fingerprints. However, the unlocking function may also be achieved in any other way, for example, using a password or a biometric feature.

What is claimed is:

1. A zipper lock comprising:
a first slider having a first locking member;
a second slider having a second locking member joinable to the first locking member such that the second slider and the first slider are locked together; and
an unlocking circuit for unlocking the otherwise joined first and second locking members.

2. The zipper lock of claim 1, wherein the unlocking circuit comprises a fingerprint sensor for detecting a fingerprint such that, upon detection that the fingerprint passes verification, the unlocking circuit unlocks the otherwise joined first and second locking members.

3. The zipper lock of claim 1, wherein the first slider has a puller for pulling the first slider and for accommodating the unlocking circuit.

4. The zipper lock of claim 1, wherein the first locking member and the second locking member are each a mechanical structure.

5. The zipper lock of claim 1, wherein the first slider has a first puller for pulling the first slider, the second slider has a second puller for pulling the second slider, and the first locking member and the second locking member are disposed on the first puller and the second puller, respectively.

6. The zipper lock of claim 1, wherein the first locking member and the second locking member are joined under a magnetic force.

7. The zipper lock of claim 1, wherein the first locking member comprises an electric magnet, the second locking member comprises a permanent magnet, and the unlocking circuit controls magnetism of the electric magnet such that the electric magnet and the permanent magnet attract or repel each other.

8. A zipper lock comprising:
a slider having a first locking member;
a lock box disposed at a terminating end of a zipper, and having a second locking member joinable to the first locking member to lock the lock box and the slider together; and
an unlocking circuit for unlocking the otherwise joined first and second locking members.

9. The zipper lock of claim 8, wherein the slider has a puller for pulling the slider and for accommodating the unlocking circuit.

10. The zipper lock of claim 8, wherein the unlocking circuit is disposed on the lock box.

11. The zipper lock of claim 8, wherein the unlocking circuit comprises a fingerprint sensor for detecting a fingerprint such that, upon detection that the fingerprint passes verification, the unlocking circuit unlocks the otherwise joined first and second locking members.

12. The zipper lock of claim 8, wherein the first locking member and the second locking member are each a mechanical structure.

13. The zipper lock of claim 8, wherein the first locking member and the second locking member are joined under a magnetic force.

14. The zipper lock of claim 8, wherein one of the first locking member and the second locking member is an electric magnet, another is a permanent magnet, and the unlocking circuit controls magnetism of the electric magnet such that the electric magnet and the permanent magnet attract or repel each other.

15. The zipper lock of claim 8, wherein the first locking member comprises a puller, and the second locking member comprises a puller recess for accommodating and locking the puller.
